(19) United States
(12) Patent Application Publication
(10) Pub. No.: US 2014/0019275 A1
(43) Pub. Date: Jan. 16, 2014

(54) Processing payment information for online orders at a local merchant's point of sale via check payment

(71) Applicants: Thomas Mackenzie Fallows, San Francisco, CA (US); Brandon Kyle Trew, San Francisco, CA (US)

(72) Inventors: Thomas Mackenzie Fallows, San Francisco, CA (US); Brandon Kyle Trew, San Francisco, CA (US)

(21) Appl. No.: 13/785,967

(22) Filed: Mar. 5, 2013

Related U.S. Application Data
(60) Provisional application No. 61/671,095, filed on Jul. 12, 2012.

(51) Int. Cl. G06Q 20/20

(52) U.S. Cl. CPC G06Q 20/202
USPC 705/21

(57) ABSTRACT

An online catalog system and method provide customers with a way to place online orders with local merchants, while providing local merchants with the ability to receive payment on an order for order basis prior to shipping the order to the customer. A local merchant's inventory and pricing information is hosted on an online catalog system. An order processing device in communication with the online catalog system is provided to the local merchant. The order processing device receives online order requests and payment information from customers via the online catalog system. The order processing devices generates a payment article at the local store comprising payment information that is then processed at the local merchant's point of sale device.

### RELATED APPLICATIONS

This application claims priority to U.S. Provisional Patent Application No. 61/671,095 filed Jul. 12, 2012 and entitled “Processing Payment Information for Online Orders at a Local Merchant's Point of Sale.” The entire contents of the above-identified priority application are hereby fully incorporated herein by reference.

### TECHNICAL FIELD

The present disclosure relates to systems and methods for purchasing items online from local merchants, and more particularly, to providing processing of payment information for online orders at a local merchant's point of sale device.

### BACKGROUND

Customers increasingly shop online for items they wish to purchase, including purchases from mobile devices like mobile phones and tablets. Many customers would like the convenience of purchasing items online from local merchants. Likewise, many local merchants would like to reach the online customer market. However, local merchants need a way to accept payments for online orders from a customer who is not necessarily physically present in the store without having to rearrange their existing financial and accounting systems. For example, many local merchants operate on an order by order basis where their accounting system requires the merchant to receive payment at the time of the transaction, in contrast to a term payment system where the merchant ships an item and invoices the customer for later payment. Further, regulatory requirements prevent local merchants from accepting a customer's credit card information over the phone or via email. Accordingly, local merchants that operate on an order by order basis and wish to fill online orders need a way to receive payment for an online order prior to shipping the item to a customer.

### SUMMARY

In certain example aspects described herein, a method for completing an online order at a local store using an online catalog system comprises receiving an online order request from a remote client device at an online catalog system, requesting payment information from the remote client device, and communicating the online order request and payment information to the order processing device.

In certain example aspects, payment information from the remote client device is first deposited in an order payment account associated with the online catalog system or with a local merchant-specific account, and the payment information for debiting the order payment account is communicated to the order processing device. In certain other example aspects, the payment information is printed on a check by a check printing device in communication with the order processing device. In certain other example aspects, a stored value card reader encodes the payment information on a stored value card. In yet another example aspect, the payment information is encrypted using an encryption key of an encryption key pair and communicated directly to a local merchant's point of sale device.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an online catalog system, in accordance with certain example embodiments.

FIG. 2 is a block flow diagram depicting a method for establishing a local merchant account with an online catalog system, in accordance with certain example embodiments.

FIG. 3 is a block flow diagram depicting a method for completing an online order from a local merchant using an online catalog system, in accordance with certain example embodiments.

FIG. 4 is a block flow diagram depicting a method for communicating an online order request to a local merchant, in accordance with certain example embodiments.

FIG. 5 is a block flow diagram depicting a method for communicating an online order request to a local merchant, in accordance with certain alternative example embodiments.

FIG. 6 is a block flow diagram depicting a method for communicating an online order request to a local merchant, in accordance with certain alternative example embodiments.

FIG. 7 is a block flow diagram depicting a method of processing payment information for an online order at a local merchant point of sale device, in accordance with certain example embodiments.

FIG. 8 is a block flow diagram depicting a method of processing payment information for an online order at a local merchant point of sale device, in accordance with certain alternative example embodiments.

FIG. 9 is a block flow diagram depicting a method of processing payment information for an online order at a local merchant point of sale device, in accordance with certain alternative example embodiments.

FIG. 10 is a block flow diagram depicting a method of processing payment information for an online order at a local merchant point of sale device, in accordance with certain alternative example embodiments.

FIG. 11 is a block diagram depicting a computer machine and module, in accordance with certain example embodiments.

### DETAILED DESCRIPTION OF EXAMPLE EMBODIMENTS

### Overview

The methods and systems described herein enable a customer to shop the inventories of local merchants and initiate an order online for purchase of those items. A “local merchant” is a merchant that operates a brick-and-mortar store but is not limited to a particular geographic area in relation to the customer. For example, a customer in New York could place an online order with a “local merchant” in San Francisco. “Online” refers to any order placed when not physically present in the store, including purchases from personal computers and mobile devices such as mobile phones and tablet computers. In addition, the methods and systems described herein enable a local merchant to accept payment information for the online order at the merchant's point of sale device. “Payment information” includes an account number and a payment amount to be debited or charged to that account number.

A local merchant registers its catalog with an online catalog system. A “catalog” includes a local merchant's inventory and pricing information. The local merchant is then provided an order processing device that communicates with the online catalog system, the remote client device, or both. In certain example embodiments, the local merchant is further provided with a payment article device. The payment article device generates payment articles comprising payment information for processing at a local merchant's point of sale device. “Processing” at a local merchant point of sale device includes accepting the provided payment information and initiating the deposit of funds into a local merchant's bank account, or in a local merchant's stored value account.

A customer can search the local merchant's inventory using an application module in communication with the online catalog system. The online catalog system comprises an online catalog index that in turn comprises the catalogs of registered merchants. Alternatively, a customer can enter the item they wish to purchase, and, optionally a local merchant from which they want to purchase the selected item. Orders placed by the customer are communicated either from the online catalog system to the local merchant's order processing device, or directly from the customer's remote client device to the local merchant's order processing device. The local merchant can provide an order confirmation indicating whether the local merchant can fill the online order request. The online catalog system may facilitate communication of payment information by first receiving and depositing payment from a customer in a order payment account, and then communicating payment information to the local merchant for debiting the order payment account. Alternatively, payment information for debiting the customer's payment account, such as a credit card account, may be communicated directly to the order processing device.

In certain example embodiments, the payment information is communicated from the online catalog system to an order processing device. The order processing device communicates with a payment article device or directly with a point of sale device. When communicating with a payment article device, the order processing device communicates executable instructions for generating a payment article that can be processed at the point of sale device. Example payment articles include a check and a stored value card. Alternatively, when the order processing device communicates directly with the point of sale device, the order processing device decodes encrypted payment information received from the online catalog system or the remote client device and securely communicates the payment information to the point of sale device for payment processing. The local merchant may then deliver the order to the customer.

The inventive functionality of the example embodiments will be explained in more detail in the following description, read in conjunction with the figures illustrating the program flow.

Turning now to the drawings, in which like numerals indicate like (but not necessarily identical) elements throughout the figures, example embodiments are described in detail.

### Example System Architectures

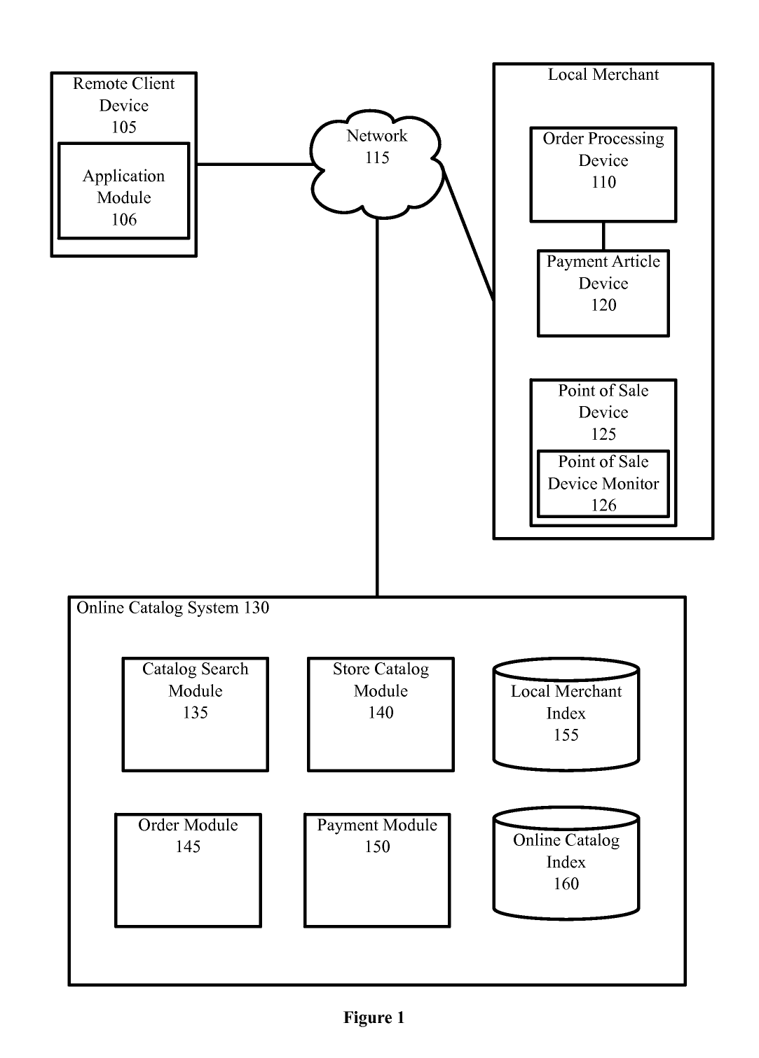

FIG. 1 is a block diagram depicting an online catalog system 100, in accordance with certain example embodiments. As depicted in FIG. 1, the system 100 can comprise a remote client device 105 executing an application module 106, an order processing device 110, a payment article device 120, and a point of sale device 125. Each of these items may be configured to communicate via a network 115.

Each network 115 includes a wired or wireless telecommunication system by which network 115 devices (including devices 105, 110, 120, 125, 130) can exchange data. For example, each network 115 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 105, 110, 120, 125, and 130 includes a device having a communication module capable of transmitting and receiving data over the network 115. For example, each network device 105, 110, 120, 125, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the remote client devices 105 are operated by end-users or customers, devices 110, 120, and 125 are operated by local merchants each operating a brick and mortar retail store, and the online catalog system 130 is operated by an online catalog system manager.

The remote client device 105 is operated by a customer and can be used to place orders with local merchants. The remote client devices 105 each include an application module 106. The application module 106 allows a customer to search and submit orders to the online catalog system 130. The application module 106 may be a browser application such as Microsoft Internet Explorer, Firefox, Google Chrome, Safari, or another suitable application for interacting with web page files maintained by the online catalog system 130 and/or other network 115 devices. The web page files can include text, graphic, images, sound, video, and other multimedia or data files that can be transmitted via the network 115. For example, the web page files can include one or more files in the Hypertext Markup Language (“HTML”). The application module 106 can receive web page files from the online catalog system 130 and can display the web page files to end users operating the remote client devices 105. The application module 106 may also comprise a software application, such as a shopping application, that resides and executes on the remote client device 105.

The order processing device 110 is operated by a local merchant and can be used to receive order requests from online customers via the online catalog system 130 or a remote client device 105. The order processing device 110 also receives payment information from the online catalog system 130 or remote client device 105 for processing online orders at the merchant's point of sale device 125. In certain example embodiments, the order processing device 110 is in communication with a payment article device 120. In certain other example embodiments, the order processing device 110 is in direct communication with, or is a component of, a point of sale device 125.

The payment article device 120 is operated by a local merchant and is used to generate a payment article comprising payment information needed to process a payment for an online order. In certain example embodiments, the payment article device 120 is a check printing device. The check printing device prints checks comprising payment information for an online order. Checks printed by the check printing device are processed at the point of sale device 125. In certain other example embodiments, the payment article device 120 is a stored value card reader/writer. The stored value card reader/writer encodes payment information onto a stored value card. Stored value cards encoded by the payment article device 120 are processed at the point of sale device 125. Example temporary stored value cards and corresponding readers include magnetic stripe readers, QR code readers, near field communication readers (NFC), and other suitable items for communicating payment information from payment articles to a point of sale device 125.

The point of sale device 125 is operated by a local merchant and is used to process payment articles generated by the payment article device 120 or payment information communicated directly to the point of sale device 125. The point of sale device 125 may further comprise a point of sale device monitor 126. The point of sale device monitor 126 may be a device in communication with the point of sale device 125 or an application module executing on the point of sale device 125. The point of sale device monitor 126 detects receipt of payment notifications at the point of sale device 125 and communicates the payment notification to the order processing device 110.

In one example embodiment, the online catalog system 130 comprises a catalog search module 135, a store catalog module 140, an order module 145, a payment module 150, a local merchant index 155, and an online catalog index 160. The catalog search module 135 provides a user interface for customers to access the online catalog system 130 via the remote client device 105 and to search the local merchant index 155 for items to purchase. The order module 145 processes orders received from a remote client device 105 and communicates the orders to the order processing device 110 of a selected merchant or merchants. The order module 145 also communicates order confirmations from the order processing device 110 to the remote client device 105. The store catalog module 140 provides a user interface to allow local merchant's to upload and update their catalog, and communicates with the order processing devices 110. The store catalog module 140 indexes each local merchant's catalog in the online catalog index 160 and indexes information on each local merchant in a local merchant index 155. The payment module 150 receives customer payment information from a remote client device 105 and deposits a payment amount indicated by the customer payment information in an order payment account, or communicates the customer payment information directly to an order processing device 110, payment article device 120, or point of sale device 125 for debiting or charging payment to the customer's payment account. Where payment information from the remote client device 105 is first deposited in an order payment account, the payment module 150 then communicates payment information to the order processing device 110, payment article device 120, or point of sale device 125 for debiting payment to the order payment account.

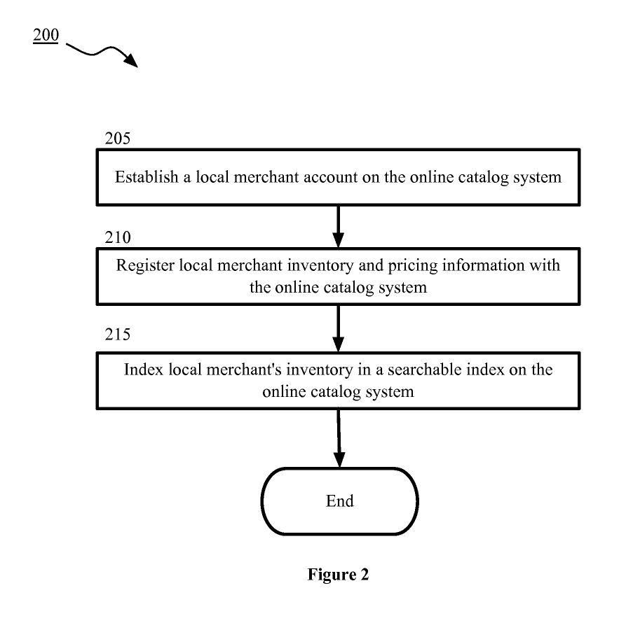

The online catalog system 130 is described in more detail hereinafter with reference to the methods depicted in FIGS. 2-8.

### Example Processes

FIG. 2 is a block flow diagram depicting a method 200 for establishing a local merchant account with the online catalog system 130, in accordance with an example embodiment. The method 200 is described with reference to the components illustrated in FIG. 1.

Method 200 begins with block 205, where the store catalog module 140 generates a user interface remotely accessible by a local merchant, such as a web site hosted by the online catalog system 130, or an online catalog system application resident on an existing merchant client device where the local merchant can register their store with the online catalog system 130. In certain example embodiments, a local merchant registers their store by submitting registration information through forms provided by a user interface. Local merchant registration information includes at least a store name and physical address and may further include information on the type of store operated by the local merchant and the product or products sold by the local merchant. Local merchant registration information may further include a service area defining the geographic area in which the local merchant can complete same-day or next-day delivery of online orders. The store catalog module 140 creates a local merchant account comprising the local merchant registration information and stores it in a local merchant index 155.

In block 210, the merchant registers their local store inventory with the store catalog module 140. In certain example embodiments, the merchant catalog module registers a local merchant's inventory by receiving from the local merchant a static inventory feed. The static inventory feed may be uploaded to the store catalog module 140 directly, or a URL may be provided where a static inventory file can be accessed from a local merchant's computer or order processing device 110 by the online catalog system 130. The static inventory file comprises product information, such as product name and UPC code, amount in stock, and current price. To maintain a current inventory file the static file may be submitted at regularly defined intervals to reflect changes in existing merchant inventory and current pricing.

In certain other example embodiments, the merchant may register with the store catalog module 140, a dynamic web feed. In certain example embodiments, the dynamic web feed may be associated with an application program interface (API). The API may comprise one or more local merchant defined rules that determine what types of inventory information will be provided to the online catalog system 130. For example, the online catalog system 130 may communicate an online order search request to the dedicated URL. The API then processes the online order search to determine if relevant inventory information is available. With or without an associated API, the dynamic web feed may provide the online catalog system 130 with real time inventory and pricing information for registered local merchants.

In certain other example embodiments, the local merchant may utilize a third party inventory management software application. In such embodiments, the necessary static or dynamic inventory feeds are established between the online catalog system 130 and the third party inventory management software application.

At block 215, the online catalog module indexes the inventory information received from the local store merchant into a searchable online catalog index 160.

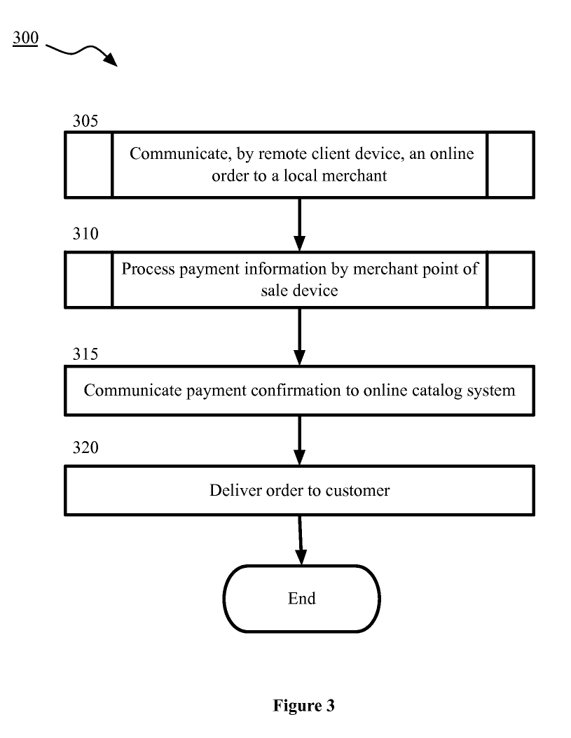

FIG. 3 is a block flow diagram depicting a method 300 for initiating an online order from a local merchant using an online catalog system 130, in accordance with certain example embodiments. The method 300 is described with reference to the components illustrated in FIG. 1.

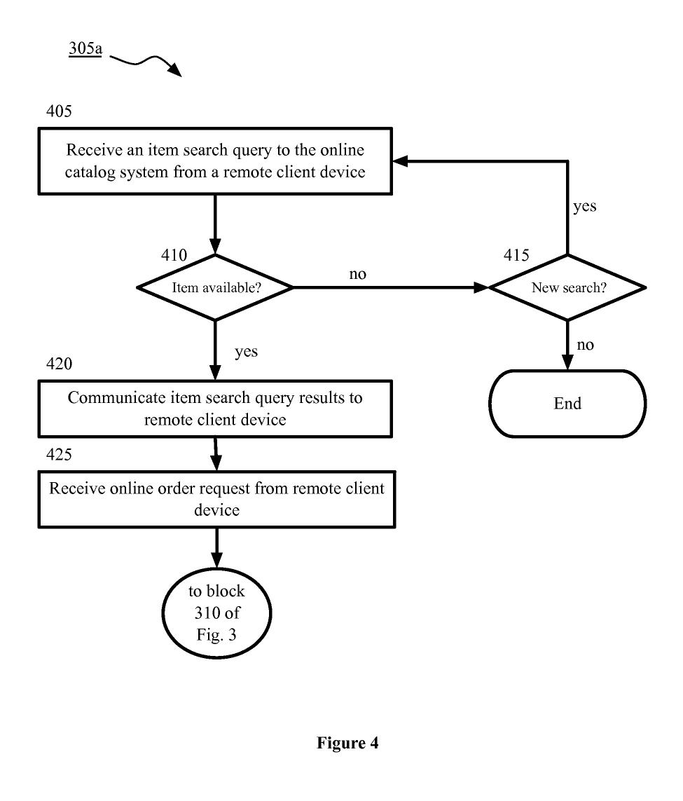

At block 305, a customer, using an application module 106 on a remote client device 105, communicates an online order request to a local merchant. Block 305 is described in further detail hereinafter with reference to FIGS. 4 to 6.

FIG. 4 is a block flow diagram depicting a method 305a for communicating an online order request to a local merchant, in accordance with certain example embodiments. The method 305a is described with reference to the components illustrated in FIG. 1.

Method 305a begins at block 405, where the catalog search module 135 receives an item search query from an application module 106 on a remote client device 105. The online search query comprises at least one or more items a customer is looking to purchase. The item search query may further comprise customer location information, such as delivery address, in order to limit the search to only those local merchants able to fill the order for same day or next day delivery. In addition, the item search query may comprise a preferred price or price range the customer is willing to pay.

At block 410, the catalog search module 135 searches the online catalog index 160 and identifies items and local merchants matching the item search criteria. In certain example embodiments, the catalog search module 135 may pre-screen the item search query based on the customer's physical address to determine if any registered local merchants provide same day or next day delivery to the customer's location. If no local merchant services the customer's location, or the item is not available based on the item search criteria, the method proceeds to block 415.

At block 415, the catalog search module 135 communicates a message to the application module 106 that the item is not available according to the submitted search criteria and requests if the customer would like to submit a new item search query. If the customer elects to submit a new search query, blocks 405 and 410 are repeated. If the customer elects not to submit a new search query, the process terminates.

Returning to block 410, if the item is available the process proceeds to block 420.

At block 420, the catalog search module 135 returns a list of search results to the application module 106. The list of search results comprises at least the matching items, a list of local merchants carrying the item, the number of such items in stock for each local merchant, and each local merchant's current price. A user may generate, using the application module 106, an online order request by selecting the item or items they wish to purchase and the local merchant or local merchants from which they wish to purchase. The application module 106 then communicates the online order request to the catalog search module 135.

In certain other example embodiments, the catalog search module 135 provides a user interface accessible by the application module 106 that allows a user to browse an online catalog of items available for purchase from registered local merchants. The online catalog is generated from the local merchant catalogs in the online catalog index 160. The user selects the item or items they wish to purchase and the local merchant or local merchants from whom they wish to purchase and stores this in an order tracking device, such as an online shopping cart. The contents of the order tracking device comprise the online order request. The application module 106 then communicates the online order request to the catalog search module 135.

At block 425, the catalog search module 135 receives the online order request from an application module 106 on the remote client device 105 confirming the item or items the customer wishes to purchase and the local merchant or merchants from which they wish to purchase the item. In certain example embodiments, the order module 145 may select a local merchant from the merchant index 155 where the online order request does not specify a local merchant or where designation of a local merchant is not allowed. The online order request may further include the user's payment information. In certain example embodiments, the online order request may further include discount information such as, but not limited to, a loyalty program identifier, group offer identifier, or a coupon identifier

At block 430, the order module 145 communicates a payment authorization to process payment using the payment information provided in the online order request to the order processing device 110. If payment information was not previously received at block 425, the order module 145 requests payment information from the application module 106 and then communicates the payment information to the order processing device 110. In certain example embodiments, payment information may be received from a separate payment module, such as an electronic wallet application. The process then proceeds to block 310 of FIG. 3.

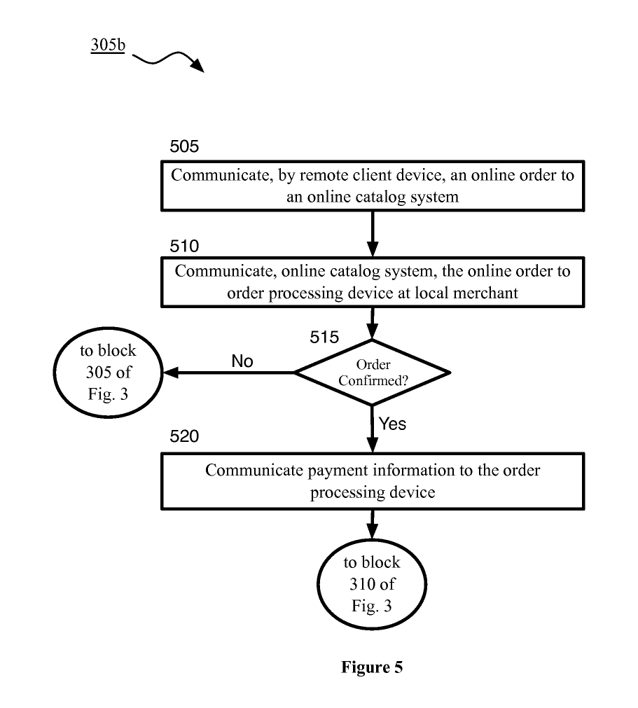

FIG. 5 is a block flow diagram depicting a method 305b for communicating an online order request to a local merchant, in accordance with certain alternative example embodiments. The method 305b is described with reference to the components illustrated in FIG. 1.

Method 305b begins at block 505, the order module 145 receives an online order request from an application module 106 on a remote client device 105. The online order request includes at least a selected item to be purchased. The online order request may further include an identity of a local merchant from which to purchase the selected item. In certain example embodiments, the order module 145 may select the local merchant from which to purchase the selected item where the online order request does not designate a local merchant, or where designation of a local merchant by the user is not allowed. The online order request may further include the user's payment information with the online order.

At block 510, the order module 145 communicates the online order request to the order processing device 110 with a request to confirm the ability to fill the online order. In certain example embodiments, the order module 145 may communicate the online order request via a push notification to the order processing device 110. In certain other example embodiments, the online order request may print an online order slip comprising the online order request at a local merchant printer or fax machine. The online order request will include the item or items to be purchased and the requested amounts as well any price limits the customer may have specified. In certain example embodiments, the online order request may further include discount information such as, but not limited to, a loyalty program identifier, group offer identifier, or a coupon identifier.

At block 515, the order module 145 receives an order confirmation from the order processing device 110 indicating whether the local merchant can or cannot fill the online order request. If the local merchant cannot fill the online order request, the online order module 145 communicates a notice to the application module 106 indicating a new online order request is required and the process returns to block 305 of FIG. 3. If the local merchant can fill the online order request, the local merchant communicates an order confirmation including a final purchase price. The order confirmation may include tax information and an indication of any discounts applied to the purchase price.

At block 520, the order module 145 communicates a payment authorization to process payment using the payment information provided in the online order request to the order processing device 110. If payment information was not previously received at block 505, the order module 145 request payment information from the application module 106 and then communicates the payment information to the order processing device 110. The process then proceeds to block 310 of FIG. 3. In certain example embodiments, payment information may be received from a separate payment module, such as an electronic wallet application.

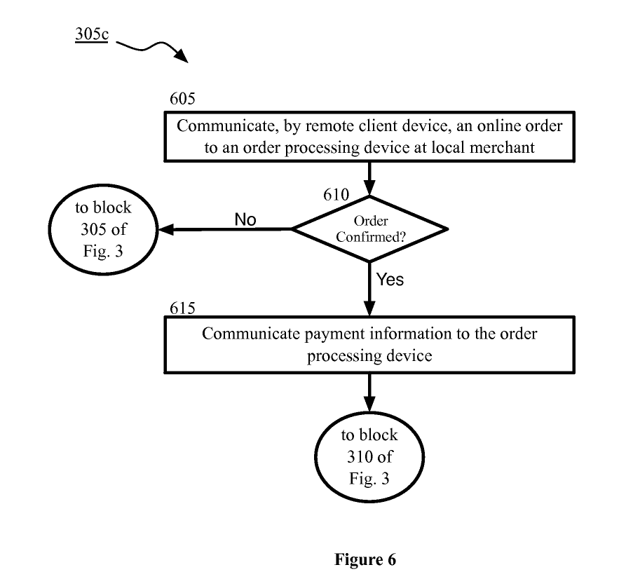

FIG. 6 is a block flow diagram depicting a method 305c for communicating an online order request to a local merchant, in accordance with certain alternative example embodiments. The method 305c is described with reference to the components illustrated in FIG. 1.

Method 305c begins at block 605, where an order processing device 110 at a local merchant receives an online order request from an application module 106 on a remote client device 105. The online order request includes at least a selected item to be purchased. In certain example embodiments, the online order request may further include customer payment information. The online order request may further include discount information such as, but not limited to, a loyalty program identifier, group offer identifier, or a coupon identifier.

At block 610, the application module 106 receives an order confirmation from the order processing device 110 indicating whether the local merchant can or cannot fill the online order request. If the local merchant cannot fill the online order, the online order module 145 communicates a notice to the application module 106 indicating a new online order request is required and the process returns to block 305 of FIG. 3. If the local merchant can fill the online order request, the local merchant communicates an order confirmation including a final purchase price. The order confirmation may include tax information and an indication of any discounts applied to the purchase price.

At block 615, the remote client device 105 communicates payment information included in the online order request. If payment information was not previously received at block 505, the order module 145 request payment information from the application module 106 and then communicates the payment information to the order processing device 110. In certain example embodiments, the remote client device communicates payment information to the payment module 150. In certain other example embodiments, the remote client device communicates the payment information to the order processing device 110. The method then proceeds to block 310 of FIG. 3.

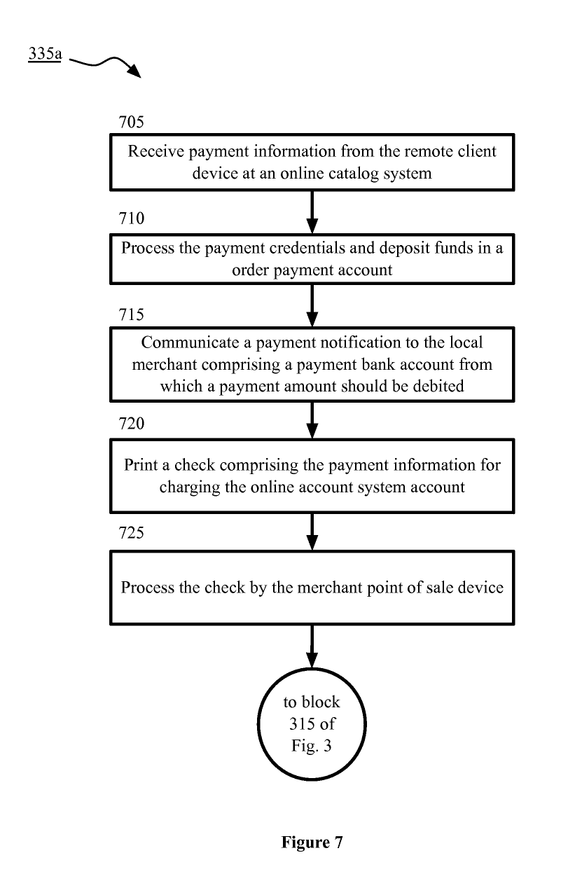

Returning to FIG. 3 at block 310, where payment for the online order is processed at the local merchant's point of sale device. Processes for completing payment for the online order at a local merchant's point of sale device 125 will be described in further detail with reference to FIGS. 7 to 10 below.

FIG. 7 is a block flow diagram depicting a method 310a for processing payment information for an online order at the local merchant's point of sale device 125. The process 310a is described with reference to the components illustrated in FIG. 1.

Method 310a begins at block 705, where the payment module 150 receives payment information for the online order from the application module 106. In certain example embodiments, the payment information is credit card payment information. In certain other example embodiments the payment information may be communicated from an electronic wallet application on a remote client device 105, or an online electronic wallet system hosted on a remote server. In certain other example embodiments, the online electric wallet application is directly associated with the online catalog system 130.

At block 710, the payment module 150 processes the payment information and deposits funds for the payment amount in an order payment account. In certain example embodiments, the order payment bank account is associated with the online catalog system 130. In certain example embodiments, the order payment account is specific to a local merchant.

At block 715, the payment module 150 communicates a payment notification to the local merchant. The payment notification includes at least a payment amount reflecting the purchased item price, tax, and any applicable discounts, such as loyalty awards or coupons, as well as a corresponding order payment account from which the payment amount should be debited.

In certain example embodiments, the payment module 150 communicates the payment notification to the point of sale device 125. An operator of the point of sale device 125 receives the payment notification and enters the payment amount in the order processing device 110. The order processing device 110 then communicates executable print instructions to the payment article device 120 for printing a check for debiting the payment amount from a corresponding payment bank account.

In certain other example embodiments, a point of sale device monitor 126 monitors the point of sale device 125 for receipt of payment notifications from the payment module 150. The point of sale device monitor 126 may be a device in communication with the point of sale device 125, or an application module executing on the point of sale device 125. The point of sale device monitor 126 detects receipt of a payment notification from the payment module 150 at the point of sale device 125 and communicates the payment notification to the order processing device 110. The order processing device 110 then communicates executable print instructions to the payment article device 120 for printing a check for debiting the payment amount from a corresponding payment account.

In certain example embodiments, the payment module 150 communicates the payment notification to the order processing device 110. The order processing device 110 then communicates executable print instructions for printing a check comprising the payment information for debiting a corresponding payment bank account for the payment amount. In certain example embodiments, the executable print instructions are communicated directly from the payment module 150 to the payment article device 120.

In certain example embodiments, the check is printed on a dedicated check printing machine configured to print checks for processing payments from the online catalog system 130. In certain other example embodiments, the executable print instructions are good for printing a single check and may not be used to print another check with the same check number.

At block 720, the payment article device 120 prints a check with the payment information for debiting the payment bank account.

At block 725, the local merchant processes the check or initiates an ACH transaction at their point of sale device 125 using the check printed by the payment article device 120.

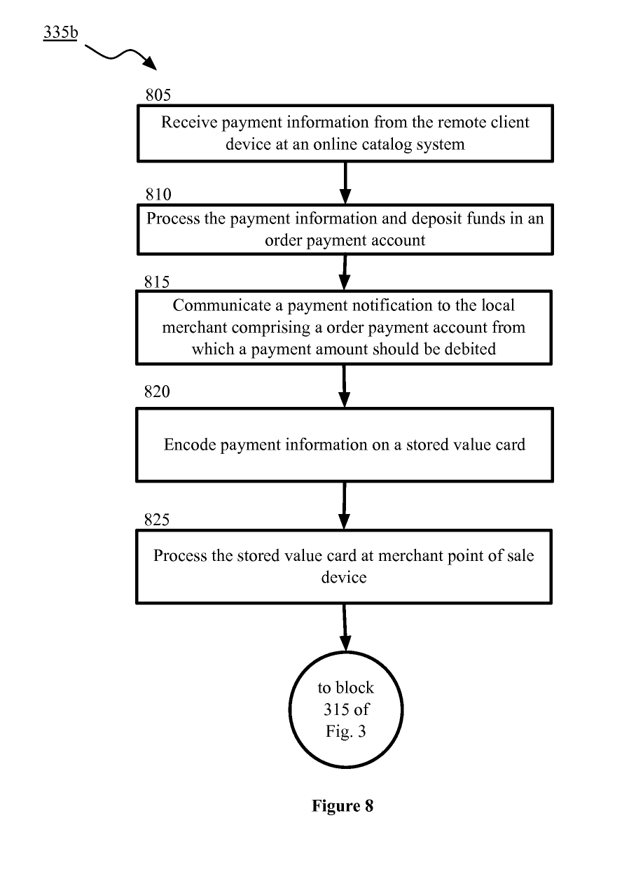

FIG. 8 is a block flow diagram depicting a method for processing payment information for an online order at a local merchant point of sale device, in accordance with certain alternative example embodiments. The process 335b is described with reference to the components illustrated in FIG. 1.

Method 335b begins at block 805. Blocks 805 to 815 proceed substantially as described above regarding blocks 705 to 715 of FIG. 7 respectively. In method 335b instead of executable print instructions, the order processing device 110 or payment module 150 communicate executable instructions to the payment article device 120 for encoding the payment information on a stored value card.

At block 820, the payment article device 120 encodes the payment information on a stored value card. In certain example embodiments, the executable instructions are communicated directly from the payment module 150 to the article payment device 120. The payment article device 120 may be a magnetic stripe reader/writer, a QR code reader/writer, a near field communication reader/writer (NFC), or other similar means for communicating payment information from a payment article to a point of sale device 125. In certain example embodiments, the stored value card is a magnetic stripe card. In certain example embodiments, the stored value card is a single use card. For example, the stored value card may be encoded such that payment information is automatically erased after the card is processed at the point of sale device 125. For example, the payment information may be encoded on the stored value card along with a flag, the flag indicating to the payment article device 120 to erase the payment information after reading the stored value card. The payment article device 120 reads the payment information and the flag from the stored value card. In response to reading the flag, the payment article device 120 deletes the payment information from the stored value card. In certain example embodiments, the payment information and flag for deleting the payment information are encoded on a magnetic stripe of a stored value card.

At block 825, the local merchant processes the payment information stored on the stored valued card at their point of sale device 125 as they would other stored value cards. The method then proceeds to block 340 of FIG. 3.

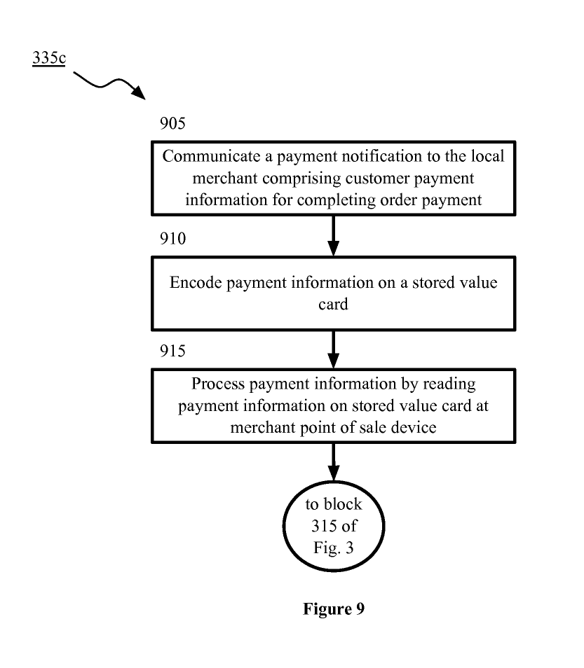

FIG. 9 is a block flow diagram depicting a method 335c for processing payment information for an online order at the local merchants point of sale device 125. The process 335c is described with reference to the components illustrated in FIG. 1.

Method 335c begins at block 905. Blocks 905-915 proceed substantially as described previously in reference to blocks 815-825 of FIG. 8 respectively. In method 335c the customer payment information is communicated directly to the order processing device 110 at block 905, rather than being deposited into an order payment account. The customer payment information includes at least a payment amount reflecting the purchased item price, tax, and any applicable discounts, such as loyalty awards or coupons. The method then proceeds to block 315 of FIG. 3.

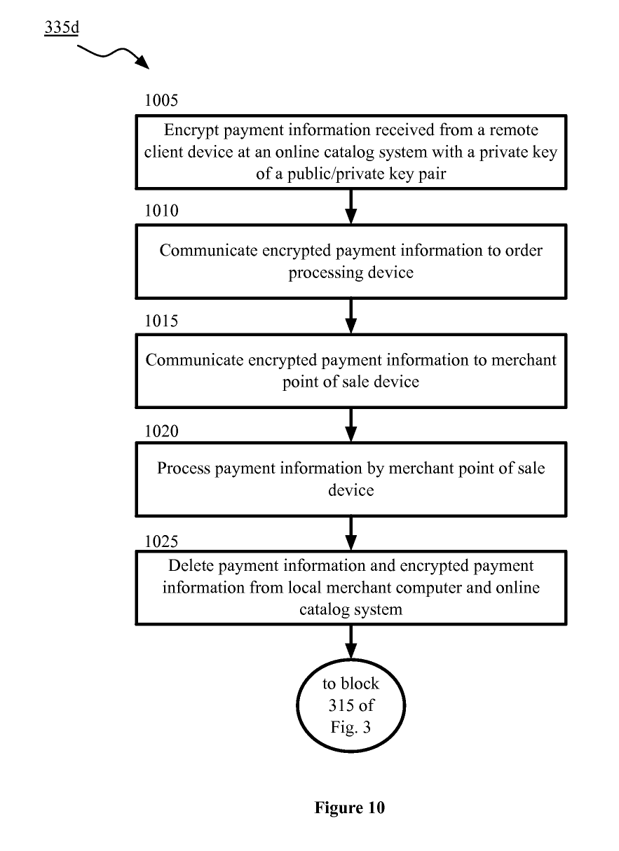

FIG. 10 is a block flow diagram depicting a method 335d for processing payment information for an online order at the local merchant's point of sale device 125. The method 335d is described with reference to the components illustrated in FIG. 1.

Method 335d begins at block 1005, where the payment module 150 encrypts the payment information received from the removed client device 105 with a payment encryption key. The payment information includes at least a payment amount reflecting the purchased item price, tax, and any applicable discounts, such as loyalty awards or coupons In certain example embodiments, the payment encryption key is a public/private key pair. In certain example embodiments, the payment module 150 uses the private encryption key of the public/private key pair encrypts the payment. In certain other example embodiments, the payment module 150 uses the public encryption key of the public/private key pair to encrypt the payment information.

At block 1010, the payment module 150 communicates the encrypted payment information to the order processing device 110. The order processing device 110 may be a stand alone device or a component of the point of sale device 125. The order processing device 110 decrypts the encrypted payment information with the corresponding public or private key of the public/private key pair used to encrypt the payment information.

At block 1015, the order processing device 110 securely communicates the payment information to the point of sale device 125. In certain example embodiments, the order processing device 110 communicates directly with the point of sale device 125 over a secure communication channel. In certain example embodiments, the order processing device 110 decrypts the encrypted payment information from the payment module 150 and re-encrypts the payment information with a second encryption key of a second public/private encryption key pair before transmitting the payment information to the point of sale device 125.

At block 1020, the point of sale device 125 processes the payment information to complete the transaction. In certain example embodiments, a decryption module resident on the point of sale device 125 decodes the encrypted payment information received from the order processing device 110 with the corresponding key of the second public/private key pair and processes the payment information.

At block 1025, the payment module deletes the customer payment information and encrypted payment information from the online catalog system, the order processing device 110, the payment article device 120, the point of sale device 125, or any other module or device in the system on which payment information was stored.

Returning to FIG. 3 at block 315, where the payment module 150 receives a final payment confirmation from the order processing device 110. In certain example embodiments, the payment module 150 further communicates a copy of the final payment confirmation to the application module 106.

At block 320, the local merchant ships the order to the customer. The item may be shipped, for example, by courier, a package delivery company, or by mail, or picked up by the customer or a customer representative.

### Other Example Embodiments

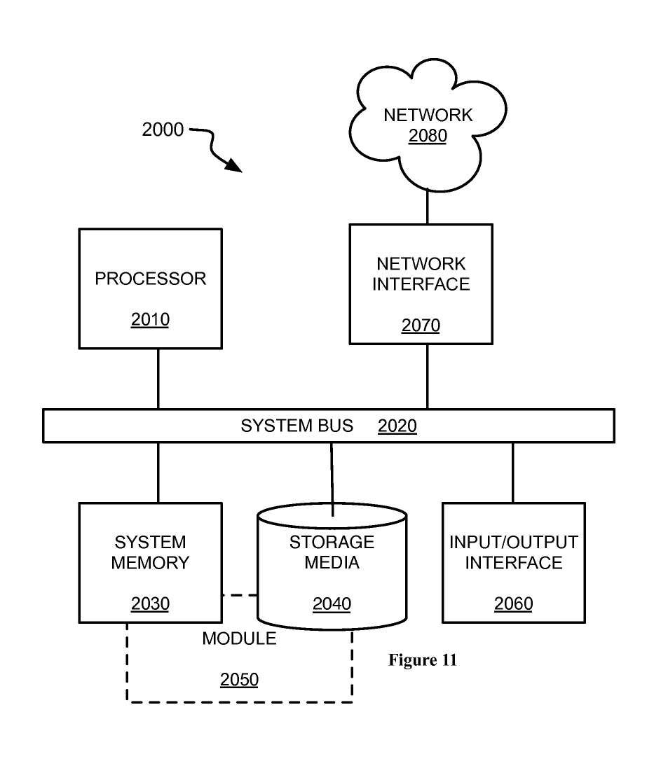

FIG. 11 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for completing online orders at local merchants, comprising:
receiving, using one or more computers and from a remote client device, an online order request, wherein the online order request comprises an identity of a local merchant from which to purchase a selected item;
communicating, using the one or more computers, the online order request to an order processing device of the local merchant;
receiving, using the one or more computers and from the order processing device of the local merchant, an indication that the local merchant can provide the selected item;
communicating, using the one or more computers, an online order confirmation and a request for payment information to the remote client device, the online order confirmation indicating that the local merchant can provide the selected item based on the indication received from the order processing device of the local merchant;
receiving, using the one or more computers, the payment information from the remote client device;
processing, using the one or more computers, the payment information received from the remote client device, wherein processing the payment information results in a deposit of funds for the online order from an account associated with the payment information to an account associated with the one or more computers; and
communicating, using the one or more computers, payment instructions to a payment article device at the local merchant to generate a payment article for processing the payment article at a point of sale device of the local merchant, the payment instructions comprising payment information to pay for the online order from the account associated with the one or more computers.

2. The method of claim 1, wherein the step of communicating payment instructions to a payment article device at the local merchant comprises:
communicating, using the one or more computers, the payment information to the order processing device at the local merchant; and
communicating, by the order processing device, executable instructions for printing or encoding the payment information on the payment article.

3. The method of claim 2, further comprising:
communicating, using the one or more computers, a payment notification comprising the payment information to the point of sale device of the local merchant;
detecting, by a point of sale device monitor in communication with the point of sale device, receipt of the payment notification at the point of sale device;
communicating, by the point of sale device monitor, the payment information from the payment notification to the order processing device.

4. The method of claim 2, wherein the payment article is a check, and wherein the check is printed at the local merchant by a check printing device at the local merchant in communication with the order processing device of the local merchant.

5. The method of claim 4, wherein the instructions for generating the check are valid for only a single use.

6. The method of claim 2, wherein the payment article is a stored value card, and wherein payment information from the payment instructions are encoded on the stored value card by a reader/writer device in communication with the order processing device.

7. The method of claim 6, wherein the stored value card is a smart card, a card comprising a QR code, or a card comprising a magnetic stripe.

8. The method of claim 7, wherein the stored value card is a card comprising a magnetic stripe.

9. The method of claim 7, wherein the payment instrument information is encoded on the stored value card so that it is deactivated after reading the stored value card at the point of sale device.

10. The method of claim 1, wherein the account associated with the one or more computers is specific to the local merchant.

11. The method of claim 1, wherein payment article device, the order processing device, and the point of sale device are the same device.

12. A computer program product, comprising:
a non-transitory computer readable medium having a computer readable program instructions embodied therein that when executed by one or more processors cause the one or more processors to complete electronic transactions, the computer readable program instructions comprising:
computer readable program instructions for receiving an online order request from a remote client device, wherein the online order request comprises a selected item to purchase;
computer readable program instructions for requesting payment information from the remote client device computer readable program instructions for receiving payment information from the remote client device;
computer readable program instructions for processing the payment information received from the remote client device, wherein processing the payment information results in a deposit of funds for the online order from an account associated with the payment information to an account associated with one or more computers that receive the payment information from the remote client device; and
computer readable program instructions for communicating payment instructions to a payment article device at the local merchant to generate a payment article for processing the payment article at a point of sale device of the local merchant, the payment instructions comprising payment information to pay for the online order from the account associated with the one or more computers.

13. The computer program product of claim 12, further comprising:
computer readable program instructions for communicating, prior to requesting the payment information, the online order request to an order processing device of the local merchant; and
computer readable program instructions for receiving an indication from the order processing device that the local merchant can provide the selected item.

14. The computer program product of claim 13, further comprising computer readable program instructions for communicating an online order confirmation to the remote client device prior to requesting the payment information from the remote claim device, the confirmation indicating that the local merchant can provide the selected item based on the indication received from the order processing device that the local merchant can provide the selected item.

15. The computer program product of claim 12, wherein the computer readable program instructions for communicating payment instructions to a payment article device at the local merchant comprises computer readable program instructions for communicating the payment information to the order processing device at the local merchant,
wherein the order processing device communicates executable instructions to the payment article device for encoding or printing the payment information on a payment article.

16. The computer program product of claim 12, wherein the computer readable program instructions for communicating payment instructions to a payment article device at the local merchant comprises computer readable program instructions for communicating a payment notification comprising the payment information to the point of sale device of the local merchant,
wherein a point of sale device monitor detects the payment notification and communicates the payment information to the order processing device, and
wherein the order processing device communicates executable instructions to the payment article device for encoding the payment information on a payment article.

17. The computer program product of claim 12, wherein the payment article is a check, and wherein the check is printed at the local merchant by a check printing device at the local merchant in communication with the order processing device of the local merchant.

18. The computer program product of claim 17, wherein the payment article device comprises the check printing device.

19. The computer program product of claim 17, wherein the instructions for generating the check are valid for only a single use.

20. The computer program product of claim 12, wherein the payment article is a stored value card, and wherein the payment information from the payment instructions are encoded on the stored value card by a reader/writer device at the local merchant in communication with the order processing device.

21. The computer program product of claim 20, wherein the payment article device comprises the reader/writer device.

22. The computer program product of claim 20, wherein the stored value card is a smart card, a card comprising a QR code, or a card comprising a magnetic stripe.

23. The computer program product of claim 22, wherein the payment instrument information is encoded on the stored value card so that it is erased after reading the stored value card at the point of sale device.

24. The computer program product of claim 12, wherein the account associated with the one or more computers that receive payment information from the remote client device is specific to the local merchant.

25. An system for completing payment of an online order at local merchants' point of sale, comprising:
a store catalog module that receives a local merchant registration request from a local merchant computer system, and receives and indexes local merchant inventory and pricing information from the local merchant computer system;
an order module that receives an order request from a remote client device, and communicates the order request to the local merchant computer system; and
a payment module that receives payment information from the remote client device, deposits funds in an account associated with the online catalog system, and communicates payment information to the local merchant for payment of the online order from the account associated with the online catalog system, and receives a payment verification from the local merchant;

26. The system of claim 25, wherein the order module receives an order confirmation from the local merchant computer system and communicates the order confirmation to the remote client device.

27. The system of claim 25, further comprising a catalog search module that receives an item search request from a remote client device, searches the online catalog index for items matching the item search request, and communicates the item search request results to the remote client device.

28. The system of claim 25, further comprising an order processing device located at the local merchant's store that receives the order request from the order module, communicates the order confirmation to the order module, and communicates a payment verification to the payment module.

29. The system of claim 28, further comprising a payment article device in communication with the order processing device, the payment module, or both, that generates a payment article comprising the payment information for payment of the online order.

30. The system of claim 29, wherein the payment module communicates payment information to the order processing device, the payment article device, or the point of sale device.

31. The system of claim 29, wherein the payment module communicates payment information to the order processing device, and the order processing device communicates executable instructions to the payment article device for generating a payment article comprising the payment information.
